(19) United States
(12) Patent Application Publication
(10) Pub. No.: US 2026/0120361 A1
(43) Pub. Date: Apr. 30, 2026

(54) AI-Based Image Processing System for Fish Shape Capture and Digitization

(71) Applicant: Kenta Nakajima, Plano, TX (US)

(72) Inventor: Kenta Nakajima, Plano, TX (US)

(21) Appl. No.: 19/157,687

(22) PCT Filed: Dec. 15, 2023
(86) PCT No.: PCT/JP2023/046054

§ 371 Date: Aug. 18, 2025

(30) Foreign Application Priority Data
Mar. 6, 2023 (JP) 2023-033898

(51) Int. Cl. G06T 11/60; G06T 5/73; G06T 5/92; G06T 11/10; G06V 10/24; G06V 10/26; G06V 10/82; G06V 40/10

(52) U.S. Cl. CPC G06T 11/60; G06T 5/73; G06T 5/92; G06T 11/10; G06V 10/242; G06V 10/26; G06V 10/82; G06V 40/10; G06T 2207/20081; G06T 2207/20084; G06T 2207/20132; G06T 2207/20192

(57) ABSTRACT

An image processing device for generating AI fish prints is provided, reducing manual effort and eliminating special photographic equipment while enhancing artistic value. The device comprises: (A) an image acquisition unit; (B) a fish-species determination unit using a first machine learning model; (C) a fish-body segmentation unit using a second machine learning model; (D) an orientation correction and layout optimization unit using a third machine learning model to determine orientation, correct it, and optimize layout; (E) a reference-positions acquisition unit using a fourth machine learning model to obtain reference positions; (F) a measurement unit that measures fish size from the fish-body partial image and the reference positions; (G) an image enhancement unit that performs impact enhancement based on an image enhancement algorithm; (H) a neural style transfer unit using a fifth machine learning model; and (I) an output unit that outputs the fish-body partial image with fish-species information.

### FIELD OF THE INVENTION

The present invention relates to an image processing system for creating AI-based Gyotaku (fish prints).

### BACKGROUND OF THE INVENTION

In Japan, “Gyotaku” is a traditional method of recording the size, shape, and unique features of a fish caught by an angler, by creating a direct print of the fish body on paper or cloth. In this specification, the term “Gyotaku” refers to traditional Japanese fish prints: after this introduction, the term “fish prints” is used for clarity. This practice, originating in the mid-19th century, is both a form of artistic expression and a means of preserving a record of a prized catch. In modern terms, it can be seen as an early form of fish imaging, where the physical impression serves as both data capture and artistic rendering.

It is known to create fish prints, which are prints capturing the likeness of a fish that has been caught. In a traditional fish print creation process, an angler first brings the caught fish to a fishing tackle shop and requests a certified measurer to record its length as a third-party verification of the catch. The angler then sends the fish, via the fishing tackle shop or other intermediaries, to a fish print technician to request the drawing of the print. However, under such a traditional process, the angler cannot consume the fish they caught. Furthermore, in many cases, it can take over a month from the request to create a fish print to the receipt of the completed work. In addition, each step of the process—measurement by a certified measurer, shipment to the fish print technician, and manual drawing—may incur significant costs. As a result, the creation of fish prints requires specialized photographic equipment, and the burden of manual work and costs is substantial. Accordingly, there is a demand for a solution that digitizes fish prints and uses AI to generate AI fish prints, thereby addressing these challenges.

Patent Document 1 (JP 2011-182255 A) discloses an imaging device with a fish print photography function, comprising: an imaging unit for capturing a fish body image; a monochrome processing unit for converting the fish body image to monochrome; an extraction unit for extracting the fish body portion from the monochrome image; a division unit for dividing the extracted fish body portion into multiple segments; and a fish print image generation unit for enlarging peripheral segments more than the central segments to generate a fish print-style image, which is then output by an output unit. This method accounts for the thickness of the fish body, enabling a more realistic fish print image.

### 3.1 Prior Art References

### 1. Foreign Patent Documents

JP 2011-182255 A Sep. 15, 2011

### Problem to be Solved by the Invention

The technology disclosed in Patent Document 1 (JP 2011-182255 A, published Sep. 15, 2011) requires a specialized imaging device equipped with specific components, leaving room for improvement in producing fish prints without the need for specialized photographic equipment. Moreover, in conventional fish print creation, adjusting the fish's orientation and layout can enhance the perceived value of the print. Manual orientation adjustments impose time and monetary costs on the angler. Patent Document 1 does not disclose automatic orientation adjustment, indicating further room for improvement in this area.

Accordingly, an object of the present invention is to provide a solution that leverages machine learning and deep learning to eliminate the need for specialized photographic equipment, reduce manual workload, and enhance the artistic value of fish prints produced through AI-based generation (“AI fish prints”).

### Means for Solving the Problems

The present inventors conducted extensive research to address the above problems and discovered that the objectives can be achieved by automating, through machine learning and deep learning with neural network weights trained for each identified fish species, the following: fish-species determination; segmentation of a fish-body region from an input image; orientation determination and correction followed by layout optimization; measurement of fish-body size; and fish-print rendering. The inventors thus completed the present invention.

Hereinafter, a fish print obtained by performing fish-species determination, fish-body segmentation, orientation determination/correction, layout optimization, measurement, and rendering using machine learning and deep learning is referred to as an “AI fish print.” Specifically, the present invention comprises six constituent inventions:
1. an invention relating to feature extraction and classification;
2. an invention relating to measurement;
3. an invention relating to rendering (fish-print creation);
4. an invention relating to fish-print creation by style transfer;
5. an invention relating to fonts and backgrounds used in fish prints utilizing style transfer; and
6. an invention relating to output.

Each item is described below. The first feature of the invention provides an image processing device (FIG. 1, image processing device 1) for AI fish prints, comprising the following units (A)-(E):
(A) Image acquisition unit configured to acquire an image containing a fish body.
(B) Fish-species determination unit configured to determine a species of the fish from the acquired image using a first trained model.
(C) Fish-body segmentation unit configured to segment a fish-body region image using a second trained model with pretrained weights specific to the determined species.
(D) Orientation correction and layout optimization unit configured to determine the orientation of the segmented fish body using a third trained model, correct the orientation, and perform layout optimization.
(E) Output unit configured to output the layout-optimized fish-body region image together with the corresponding species.

The image acquisition unit is not limited to specialized imaging hardware; thus, image processing for creating AI fish prints can be performed from ordinary photographs without dedicated capture equipment. The fish-species determination unit automatically infers the species via the first trained model, enabling even non-experts to identify the species immediately and eliminating manual burden in subsequent segmentation.

Fish-body contours differ among species. Without prior species determination, machine-learning-based segmentation may follow incorrect boundaries. By leveraging the predicted species and species-specific pretrained weights, the fish-body segmentation unit produces accurate region masks tailored to morphological differences.

Likewise, orientation-defining cues vary by species. Orientation determination without prior classification risks misalignment. Using the predicted species and a trained model, the orientation correction and layout optimization unit corrects rotation with high accuracy and performs layout optimization accordingly, thereby enhancing the value of the resulting fish print.

Overall, the first feature automates a computer-vision pipeline-species determination, fish-body segmentation, and orientation correction/layout optimization-without manual work by anglers, appraisers, or technicians, thereby markedly reducing workload and yielding consistently optimal placement for AI fish print creation.

### Effects of the Invention

The present invention provides means that, in creating AI fish prints, do not require special imaging equipment, reduce manual workload, and enhance the artistic value of the resulting fish prints.

### BRIEF DESCRIPTION OF THE DRAWINGS

FIG. 1 is a block diagram illustrating one example of the hardware and software configuration of an image processing system S according to the present embodiment.

FIG. 2 is one example of a fish print table 121.

FIG. 3 is a main flowchart showing one example of a preferred flow of image processing performed by the image processing device 1.

FIG. 4 is a diagram following FIG. 3.

FIG. 5 is a diagram following FIG. 4.

FIG. 6 is one example of an image of a fish body used as an input image.

FIG. 7 is one example of a fish body region image cropped from the image of FIG. 6 based on the determined fish species.

FIG. 8 is one example of a monochrome image obtained by correcting the orientation of the fish body image.

FIG. 9 is an explanatory diagram relating to the acquisition of reference positions from an image.

FIG. 10 is one example of an image in which the visual impact of the image of FIG. 8 is emphasized.

FIG. 11 is one example of a fish print image obtained by converting the artistic style of the fish body image of FIG. 10.

### MODE FOR CARRYING OUT THE INVENTION

The following describes, in detail, one example embodiment of the present invention with reference to the accompanying drawings.

### 8.1 Image Processing System S

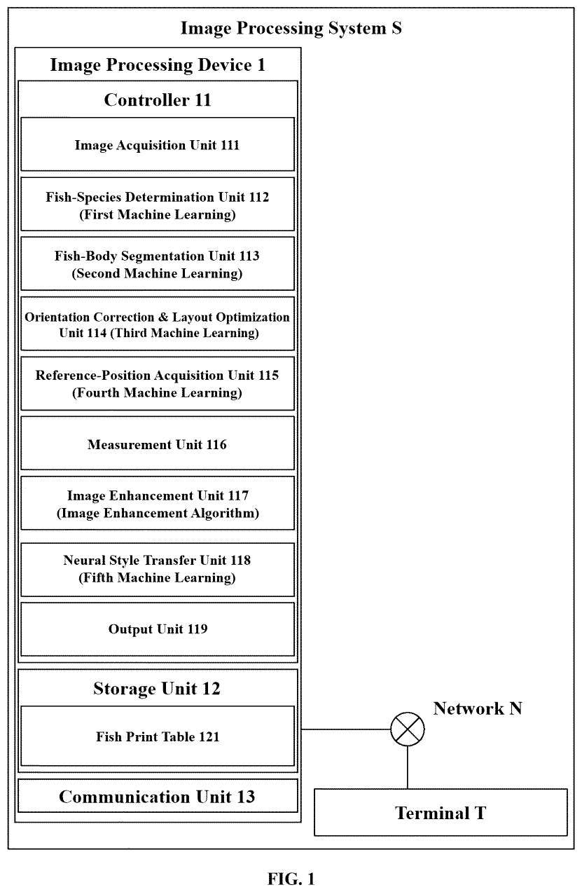

FIG. 1 is a block diagram illustrating one example of the hardware and software configuration of an image processing system S according to the present embodiment.

Hereinafter, one preferred mode of the image processing system S will be described with reference to FIG. 1.

The image processing system S includes at least an image processing device 1. Preferably, the image processing system S further includes a terminal T that is communicable with the image processing device 1 via a network N. Hereinafter, the image processing system S may simply be referred to as the “system S.”

### 8.2 Image Processing Device 1

The image processing device 1 includes a controller 11, a storage unit 12, and a communication unit 13.

The type of the image processing device 1 is not particularly limited. Examples include a server device, a cloud server, or a terminal. The terminal may be, for example, a personal computer, a laptop computer, a smartphone, or a tablet device.

When the image processing device 1 is a terminal, it is preferable for the device to further include an imaging unit such as a camera, and a display unit capable of displaying images.

### 8.3 Controller 11

The controller 11 includes a CPU (Central Processing Unit), RAM (Random Access Memory), and ROM (Read-Only Memory).

The controller 11 cooperates, as necessary, with the storage unit 12 and/or the communication unit 13. The controller 11 implements software components of the program executed by the image processing device 1 in the present embodiment, such as:
Image acquisition unit 111
Fish-species determination unit 112
Fish-body segmentation unit 113
Orientation correction and layout optimization unit 114
Reference-positions acquisition unit 115
Measurement unit 116
Image enhancement unit 117
Neural style transfer unit 118
Output unit 119

The functions provided by each of these software components will be described later in the explanation of a preferred flow of image processing.

### 8.4 Storage Unit 12

The storage unit 12 is a device in which data and/or files are stored, and includes a data storage section such as a hard disk, a semiconductor memory, a recording medium, or a memory card.

The storage unit 12 may also include a mechanism that allows connection, via the network N, to a storage device or storage system such as a NAS (Network Attached Storage), SAN (Storage Area Network), cloud storage CS, file server, and/or distributed file system.

The storage unit 12 stores, among other things, a program executed by a microcomputer, a fish print table 121, a first machine learning model, a second machine learning model, a third machine learning model, a fourth machine learning model, an image enhancement algorithm, and a fifth machine learning model.

### 8.5 Fish Print Table 121

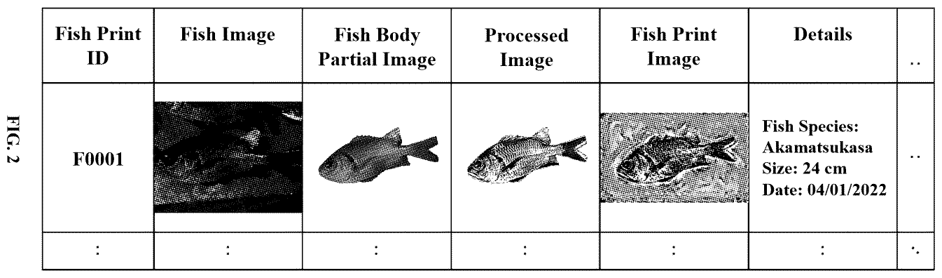

FIG. 2 illustrates one example of the fish print table 121. The fish print table 121 stores fish images and fish print images generated based on such images.

Preferably, the fish print table 121 further stores:
Partial images of a fish body (fish body region images) cropped from the fish images, and
Post-processed images of the fish body in which contrast normalization and edge enhancement have been performed through a Color Dodge process.

The Color Dodge process is an image processing technique that overlays a pattern onto an image and brightens the image's colors in proportion to the whiteness of the overlaid pattern.

The fish print table 121 also preferably stores various types of information relating to the fish, such as fish species, fish size, and date/time information.

The fish print table 121 preferably associates a fish print ID capable of identifying the above information with corresponding user information. This allows the image processing device 1 to manage the aforementioned information using the fish print ID.

In the example shown in FIG. 2, the fish print ID “F0001,” a fish image acquired from a terminal T or the like, a fish body image (fish body region image) in which orientation correction and layout optimization has been performed on the fish body portion cropped from the fish image, a post-processed fish body image obtained from the above via the Color Dodge process to perform contrast normalization and edge enhancement, a fish print image generated by AI-based style transfer, the fish species “Akamatsukasa” (Bigscale Soldierfish), the fish size “24 cm,” and the date/time “April 1, 2022” are all associated with one another and stored.

Accordingly, the image processing device 1 can perform image processing on the acquired image of an Akamatsukasa, and output the fish print image, the fish species “Akamatsukasa,” and the fish size “24 cm”.

### 8.6 First Machine Learning

Referring back to FIG. 1, the first machine learning is a trained model for classifying fish species from images. The first machine learning may include, for example, binary classification and/or multiclass classification. The method employed in the first machine learning is not particularly limited.

The first machine learning may be integrated with the second machine learning described below. As one example, an integrated model may be an object detection model that outputs both the type of a detected object (fish body) and the corresponding partial image.

### 8.7 Second Machine Learning

The second machine learning is a trained model for cropping a partial image corresponding to the fish body (fish body region image) according to the classified species. The second machine learning may include neural network-based models related to semantic segmentation, instance segmentation, object detection, and/or principal component analysis.

The method of the second machine learning is not particularly limited. For example, it may employ feature detection techniques such as YOLO (You Only Look Once) or Mask R-CNN. Preferably, the second machine learning is capable of outputting the type of fish species, allowing it to be configured as an integrated model with the first machine learning.

### 8.8 Third Machine Learning

The third machine learning is a trained model for determining the orientation of a fish body appearing in an image. It may combine:
a model for detecting fish body features such as the eye, pectoral fin, and caudal fin, and
a model for determining the major axis representing the orientation of the cropped fish body.

The third machine learning may include, for example, neural network-based models related to semantic segmentation, instance segmentation, object detection, and/or principal component analysis. The method employed is not particularly limited.

### 8.9 Fourth Machine Learning

The fourth machine learning is a trained model for acquiring, from an image, reference positions used for measuring size, such as scale markings or numerals recorded on a ruler or measuring tape (hereinafter referred to as the “reference positions”). The fourth machine learning may include, for example, a model that detects features of reference objects for determining fish body size, such as ruler scale marks or printed numerals.

It may include neural network-based models related to semantic segmentation, instance segmentation, object detection, and/or principal component analysis. The method employed is not particularly limited.

### 8.10 Image Enhancement Algorithm

The image enhancement algorithm enhances an image by applying the Color Dodge technique, contrast normalization, and edge enhancement. The Color Dodge technique provides a visual effect in which the fish body appears as though illuminated by a spotlight on a stage. As a result, in an image to which this technique is applied, the bright portions of the fish body appear distinctly while the dark portions appear blurred.

In addition, the combination of contrast normalization and edge enhancement prevents the disappearance of contours even in blurred areas. Details of image enhancement processing using the image enhancement algorithm will be described later in the image enhancement step.

### 8.11 Fifth Machine Learning

The fifth machine learning is a trained model for style transformation. It may include, for example, AI-based style transfer techniques such as Neural Style Transfer, Stable Diffusion, or similar approaches. Preferably, the fifth machine learning can output an image after AI style transfer, based on the target image and information relating to the artistic style.

Furthermore, the fifth machine learning can also be applied to AI-based style transfer of the background and fonts used in a fish print, in accordance with user preferences. The method employed is not particularly limited.

### 8.12 Communication Unit 13

The communication unit 13 enables the image processing device 1 to connect to the network N and communicate with various terminals such as terminal T. The specific type of communication interface is not particularly limited, as long as it enables such functionality. Examples include:
a wireless device compatible with mobile cellular networks,
a device capable of connecting to wireless LAN (Wi-Fi), and
a network card compliant with Ethernet standards.

### 8.13 Other Components

The image processing device 1 may further include:
an imaging unit (not shown) capable of capturing fish images;
an input unit (not shown) for inputting various commands to the controller 11; and
a display unit (not shown) for displaying generated AI fish print images and other outputs.

Such an image processing device may be implemented as a smartphone, tablet, or other terminal equipped with a dedicated application (program) capable of executing the image processing functions described herein.

### 8.14 Network N

The network N may be of any type that enables communication between the image processing device 1 and terminal T, and is not particularly limited. Examples include:
the Internet,
mobile cellular networks, and
wireless local area networks (wireless LAN or Wi-Fi).

### 8.15 Terminal T

The terminal T may be any device capable of acquiring a fish image, and is not particularly limited. The terminal T may be integrated with the image processing device 1, or implemented as a separate device.

When implemented separately, it is preferable that the terminal T be capable of:
transmitting the acquired fish image to the image processing device 1, and
receiving and displaying the fish print image output by the image processing device 1.

Examples of terminal T include camera-equipped devices such as smartphones or tablets on which an appropriate program is installed to perform these functions.

### MAIN FLOWCHART OF IMAGE PROCESSING PERFORMED BY THE IMAGE PROCESSING DEVICE

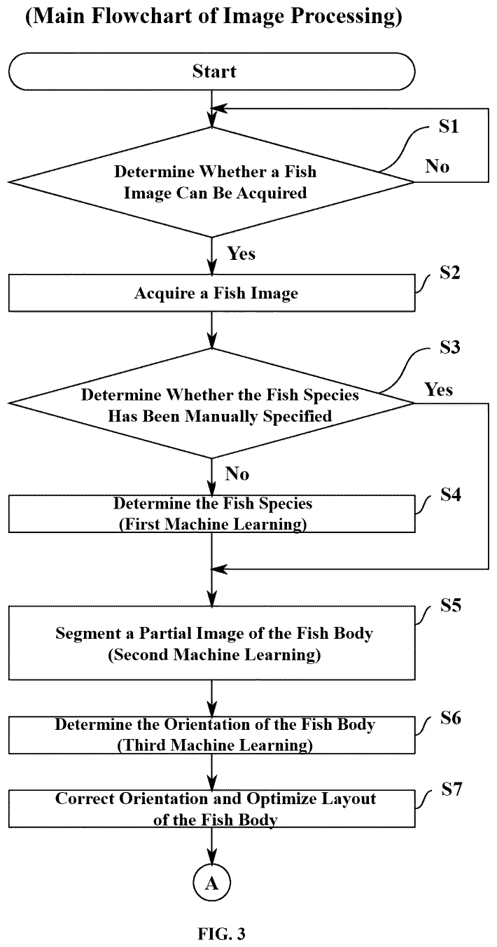

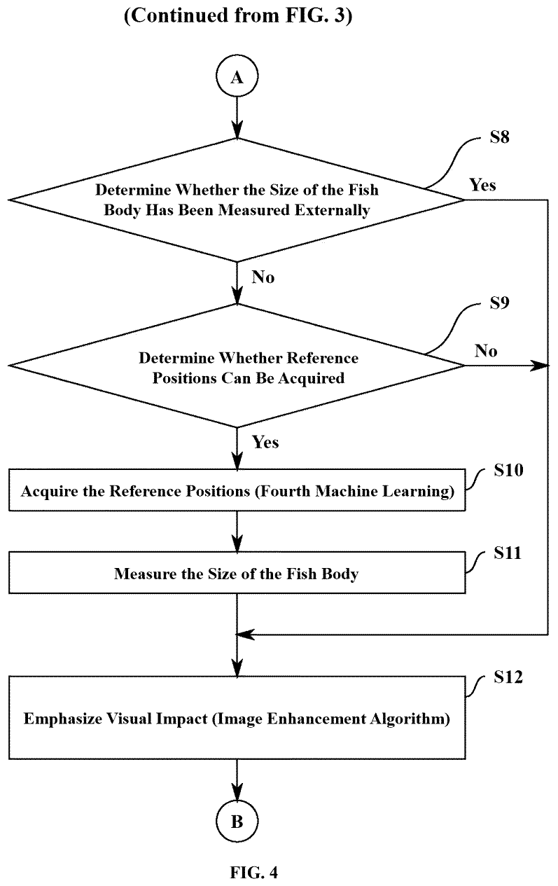

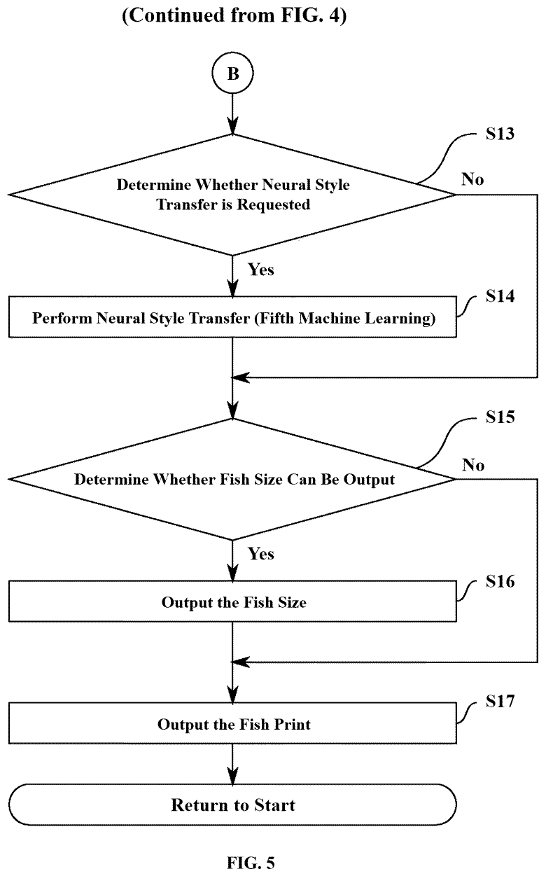

FIG. 3 is a main flowchart illustrating one preferred example of image processing performed by the image processing device 1. FIG. 4 follows FIG. 3, and FIG. 5 follows FIG. 4. The preferred processing flow described below will be explained with reference to FIGS. 3 through 5. Hereinafter. “processing based on machine learning” may simply be referred to as “machine learning.”

The image processing device 1 first executes an acquisition step, from Step S1 to Step S2, in order to acquire an image of a fish.

### 9.1 Step S1: Determine Whether a Fish Image can be Acquired

The control unit 11 described in FIG. 1, in cooperation with the storage unit 12 and communication unit 13, executes the image acquisition unit 111. The control unit 11 then performs processing to determine whether an image of a fish can be acquired (Step S1: Fish Image Acquisition Feasibility Determination Step). If it is determined that acquisition is possible, the control unit 11 proceeds to Step S2. If not, the process returns to Step S1.

The method of determining acquisition feasibility is not particularly limited. For example, the determination step may include one or more of the following:
determining that acquisition is possible upon receiving a fish image from terminal T;
determining that acquisition is possible when a fish image has been captured by the image processing device 1 itself; or
determining that acquisition is possible when a fish image has been designated within the image processing device 1

### 9.2 Step S2: Acquire a Fish Image

The control unit 11 executes processing to acquire a fish image (Step S2: Image Acquisition Execution Step). Preferably, this step includes a procedure for storing the acquired fish image in the fish print table 121. The image acquired in Step S2 is used in subsequent processing, including fish species classification and segmentation of partial images corresponding to the fish body.

In the species determination steps (Steps S3-S4), the user may alternatively enter the fish species manually. This allows the image processing device 1 to generate an AI fish print that better reflects the user's preferences.

9.3 Step S3: Determine Whether the Fish Species has been Manually Specified

The control unit 11 executes the fish-species determination unit 112 in cooperation with the storage unit 12. The control unit 11 then performs processing to determine whether the fish species has been manually specified (Step S3: Fish Species Manual Specification Determination Step).

If it is determined that the fish species has been specified, the control unit 11 stores the specified fish species in the fish print table 121 and proceeds to Step S5. If not, the process proceeds to Step S4.

### 9.4 Step S4: Determine the Fish Species

Next, the control unit 11 executes the fish-species determination unit 112 in cooperation with the storage unit 12. When the first machine learning used in the fish-species determination unit 112 and the second machine learning used in the fish-body segmentation unit 113 (described later) are implemented as a single integrated model, it is preferable that this series of processes be performed as one integrated process. Conversely, when the first and second machine learning models are implemented separately, it is preferable that the processes be carried out separately.

The following description illustrates the case where the processes are executed separately, but the same applies when they are executed as an integrated process.

The control unit 11 determines the fish species from the image acquired in Step S2 based on the first machine learning (Step S4: Fish-Species Determination Step). Preferably, this step includes a procedure for storing the determined fish species in the fish print table 121. The process then proceeds to Step S5.

### 9.5 Step S5: Segment a Partial Image of the Fish Body

The control unit 11 executes the fish-body segmentation unit 113 in cooperation with the storage unit 12. Based on the fish species determined in Step S3 or S4, the control unit 11 executes the second machine learning model to segment a partial image corresponding to the fish body from the image acquired in Step S2 (Step S5: Fish Body Partial Image Segmentation Step).

Preferably, this step includes a procedure for storing the segmented partial image in the fish print table 121. The process then proceeds to Step S6.

By using the second machine learning model trained in accordance with fish species, the image processing device 1 can perform segmentation based on pre-trained weights specific to each species. This allows the device to improve segmentation accuracy.

Subsequently, in Step S6, the image processing device 1 determines the orientation of the partial image of the fish body, and then proceeds to Step S7 for orientation correction and layout optimization.

### 9.6 Step S6: Determine the Orientation of the Fish Body

The control unit 11 executes the orientation correction and layout optimization unit 114 in cooperation with the storage unit 12. Here, the control unit 11 determines the orientation of the fish body in the partial image segmented in Step S5 (Step S6: Orientation Determination Step).

In this context, orientation determination refers to identifying whether the lateral side of the fish body captured in the photograph, with the head facing forward, is oriented to the right or to the left.

The orientation determination step may include, for example:
performing principal component analysis to obtain the first and second axes of the fish body as principal axes in a principal component coordinate system,
detecting features of the fish body such as the eye, pectoral fin, and caudal fin using deep learning, and
determining the orientation of the fish body based on the relative positional relationship between the detected features and the principal axes.

The process then proceeds to Step S7.

### 9.7 Step S7: Correct Orientation and Optimize Layout of the Fish Body

The control unit 11 executes the orientation correction and layout optimization unit 114 in cooperation with the storage unit 12. Based on the orientation determined in Step S6, the control unit 11 corrects the orientation of the fish body in the partial image segmented in Step S5 and performs a layout optimization process (Step S7: Orientation Correction and Layout Optimization Step). The process then proceeds to Step S8.

This step may include a series of procedures for rotating and vertically and/or horizontally flipping the image so that the fish body is oriented in a predetermined direction. For example, when orienting the fish body toward the lower left, the procedure may involve rotating and, if necessary, flipping the image vertically and/or horizontally so that in the corrected image:
the eye of the fish is positioned on the left,
the pectoral fin is positioned at the bottom, and
the caudal fin is positioned on the right,
based on the detected features in Step S5. The same applies when the fish body is to be oriented in other directions.

In addition, the orientation correction and layout optimization step may include a procedure for rotating the image so that the principal axis obtained by the third machine learning model using principal component analysis forms a predetermined angle with the vertical and/or horizontal direction of the image.

The step may further include correcting the size and/or placement of the fish body partial image based on the orientation determined in Step S6. This makes it possible to further optimize the placement of the fish body partial image in the AI fish print.

It is preferable that the image processing device 1 be capable of executing the measurement determination step (Step S8), the reference positions acquisition steps (Steps S9 to S10), and the measurement step (Step S11), so that the size of the fish body can be measured.

9.8 Step S8: Determine Whether the Size of the Fish Body has been Measured Externally

The control unit 11 executes the measurement unit 116 in cooperation with the storage unit 12. It then performs a process to determine whether the size of the fish body has been measured externally (Step S8: Measurement Determination Step).

If measurement has been performed, the process proceeds to Step S12. If not, the process proceeds to Step S9.

### 9.9 Step S9: Determine Whether Reference Positions can be Acquired

The control unit 11 executes the reference-positions acquisition unit 115 in cooperation with the storage unit 12. It then determines whether reference positions serving as a baseline for size measurement can be acquired from the image obtained in Step S2 (Step S9: Reference Positions Acquisition Feasibility Determination Step).

If it is determined that the reference positions can be acquired, the process proceeds to Step S10. If not, the process proceeds to Step S12.

The method of this determination is not particularly limited. For example, the procedure may include detecting an object serving as a size reference (calibration target) in the image obtained in Step S2 by means of machine learning-based object detection, and determining that the reference positions can thereby be acquired.

The object serving as a size reference is not particularly limited. Common examples include a ruler, scale markings or numerals printed on a measuring tape. Alternatively, items such as a 100-yen coin or a plastic bottle container may also serve as calibration targets.

### 9.10 Step S10: Acquire the Reference Positions

The control unit 11 executes the reference-positions acquisition unit 115 in cooperation with the storage unit 12. It then performs processing to acquire multiple reference positions from the image obtained in Step S2 based on the fourth machine learning model (Step S10: Reference Positions Acquisition Execution Step). The process then proceeds to Step S11.

### 9.11 Step S11: Measure the Size of the Fish Body

The controller 11 executes the measurement unit 116 in cooperation with the storage unit 12. The controller 11 then performs processing to measure the size of the fish body based on the image obtained in Step S2 and the reference positions acquired in Step S10 (Step S11: Measurement Step). Thereafter, the controller 11 proceeds to Step S12. Preferably, the measurement step includes storing the measured fish body size in the fish print table 121.

The measurement step is not particularly limited. For example, the measurement step may include a procedure in which principal component analysis is performed on the multiple reference positions acquired in Step S10 to determine the orientation of a ruler or measuring tape, and the fish body size is measured from the relative relationship between the size of the ruler or tape measure along the principal axis corresponding to its orientation and the size of the segmented fish body image obtained in Step S5.

The measurement step may further include a procedure for obtaining the size of the fish body measured from the fish image by an external program. Examples of such external programs include, for instance, a program that measures the distance between two points tapped by a user in an image captured with a smartphone camera.

### 9.12 Step S12: Emphasize Visual Impact

The controller 11 executes the image enhancement unit 117 in cooperation with the storage unit 12. First, the controller 11 applies a Color Dodge process to the segmented fish body image obtained in Step S5, whose orientation was corrected and placement optimized in Step S7. Subsequently, contrast optimization is performed by normalizing the color and tonal contrast of the resulting image. Furthermore, an edge enhancement process is applied to the optimized image (Step S12: Image Enhancement Step). Through this series of procedures, the visual impact of the segmented fish body image from Step S5 is emphasized, resulting in a fish print image that differs from a simple grayscale conversion. Preferably, this step includes storing the generated fish print image in the fish print table 121. Thereafter, the controller 11 proceeds to Step S13. The image enhancement step may be skipped in accordance with user preference, in which case the process proceeds directly to Step S13.

Here, the Color Dodge process is described in detail. The Color Dodge process produces an image effect in which the fish body appears as if illuminated by a spotlight on a stage-bright portions appear distinctly clear, while dark portions appear softened. By additionally normalizing the color and tonal contrast, excessive coloration and brightness are prevented, achieving visual balance. Furthermore, the edge enhancement of the fish's outline, scales, fins, eyes, mouth, and lateral line ensures that even those portions blurred by the Color Dodge process retain definition. These three combined image processing techniques differ from conventional monochrome conversion and are not found in existing patents relating to digital fish prints.

The contrast normalization process may further include a procedure in which predetermined options relating to color intensity and brightness are displayed, and the intensity is adjusted based on the settings selected according to user preference.

It is preferable that the image processing device 1 further include the neural style transfer step from Step S13 to Step S14. This enables the device to generate a fish print image transformed into an artistic style according to user preference, thereby enhancing the artistic value of the AI fish print.

### 9.13 Step S13: Determine Whether Neural Style Transfer is Requested

The controller 11 executes the neural style transfer unit 118 in cooperation with the storage unit 12 and the communication unit 13. The controller 11 then determines whether a neural style transfer has been requested (Step S13: Neural Style Transfer Request Determination Step). If it is determined that a request has been made, the controller 11 proceeds to Step S14. If it is determined that no request has been made, the controller 11 proceeds to Step S15.

The neural style transfer request determination step is not particularly limited. For example, the step may include determining that a neural style transfer has been requested when the user has instructed such a transformation via the terminal T or the like.

### 9.14 Step S14: Perform Neural Style Transfer

The controller 11 executes the neural style transfer unit 118 in cooperation with the storage unit 12. Based on the fifth machine learning model, the controller 11 performs a neural style transfer on either the segmented fish body image obtained in Step S5, or on the image that has undergone the Color Dodge process followed by contrast normalization and edge optimization (Step S14: Neural Style Transfer Execution Step). This enhances the artistic value of the AI fish print.

The neural style transfer execution step may also be used to modify the font and background design used in the fish print. Preferably, this step includes storing the transformed fish print image in the fish print table 121. After completion, the controller 11 proceeds to Step S15.

Even when it is not possible to measure the size of the fish body, the image processing device 1 preferably executes the output step in Step S17. When the reference positions acquisition step and measurement step are executed, the output step preferably includes the processing from Step S15 to Step S16 relating to outputting the fish size.

### 9.15 Step S15: Determine Whether Fish Size can be Output

The controller 11 executes the output unit 119 in cooperation with the storage unit 12. The controller 11 then performs a process to determine whether the fish size can be output (Step S15: Fish Size Availability Determination Step). If it is determined that output is possible, the controller 11 proceeds to Step S16. If it is determined that output is not possible, the controller 11 proceeds to Step S17.

The fish size availability determination step may include, for example, a procedure in which it is determined that the fish size is available for output when the size has been measured in the measurement step.

### 9.16 Step S16: Output the Fish Size

The controller 11 executes the output unit 119 in cooperation with the storage unit 12 and the communication unit 13 (Step $16: Fish Size Output Step). In this step, if the fish size has been obtained in Step S11, that information is passed to Step S17. If the fish size has not been obtained, this step is omitted.

### 9.17 Step S17: Output the Fish Print

The controller 11 executes the output unit 119 in cooperation with the storage unit 12 and the communication unit 13. The controller 11 performs a process to output the fish print, which has been oriented and rendered through the processes from Step S1 to Step S14, together with the fish species determined through the processes from Step S3 to Step S4 (Step S17: Output Execution Step). If it is determined in Step S15 that the fish size cannot be output, the information regarding the size may be omitted.

### 9.18 SNS Output Step

The output execution step may preferably further include, in accordance with the user's instruction, an SNS output step (not shown) for outputting the above fish print and related data to social media platforms. This enables, for example, when hosting an online fishing tournament using fish prints, the organizer and participants to promote the created AI fish prints and the original images via various social media platforms. This can help the organizer attract additional participants through such promotions, and the operator of the image processing system S can expect an increase in the number of users as a result.

### 9.19 NFT Output Step

The output execution step may preferably further include, in accordance with the user's instruction, an NFT output step (not shown) for outputting the above fish print and fish size information to a blockchain as an NFT. This allows the user to demonstrate ownership of the created fish print by means of reliable proof—the fish print and size information recorded as a tamper-resistant NFT on the blockchain.

### EXAMPLE USAGE OF THE IMAGE PROCESSING SYSTEM S

The following describes example usages of the image processing system S according to the present embodiment.

### 10.1 Generation of AI Fish Prints

First, an example is described in which a user who has caught a fish generates an AI fish print.

### 10.1.1 Acquisition of Fish Image

A user who has caught a fish provides an image of the caught fish to the image processing device 1, for example, by photographing it with a smartphone or similar device. The image processing device 1 acquires the image of the fish. FIG. 6 shows an example of such a fish image. As shown in FIG. 6, because the fish image includes other fish captured in the background, the image cannot be directly used for generating an AI fish print. Therefore, processing is required to crop, select, and otherwise extract the fish body image to be used for fish print creation.

### 10.1.2 Fish Species Determination and Cropping of Fish Body Image

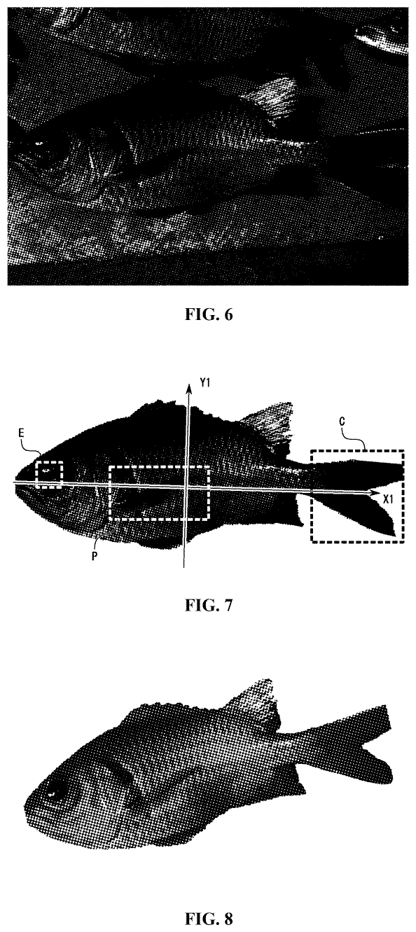

The image processing device 1 determines, from the image shown in FIG. 6, that the fish species is Akamatsukasa, and crops the fish body image based on this determination. FIG. 7 shows an example of the fish body image cropped from the image in FIG. 6 according to the determined fish species.

### 10.1.3 Orientation Correction

The image processing device 1 determines the orientation of the fish body. Based on the determined orientation, the image processing device 1 corrects the orientation of the fish body and performs optimal placement. In the example shown in FIG. 7, the first principal axis X1 and second principal axis Y1 of the fish body, as well as the eye E, pectoral fin P, and caudal fin C, are detected by the third machine learning process, enabling determination of the fish body orientation. FIG. 8 shows an example of a monochrome image obtained by correcting the orientation of the fish body image. In the example shown in FIG. 8, the image processing device 1 automatically corrects the placement of the fish body so that it faces the lower-left direction based on the determined orientation.

### 10.1.4 Measurement of Fish Size

The image processing device 1 acquires multiple reference positions and measures the size of the fish body based on these reference positions. FIG. 9 is an explanatory diagram relating to acquisition of reference positions from an image. In the example shown in FIG. 9, the numerals “1” through “5” on the measuring tape are acquired as first to fifth reference positions L1 to L5, respectively. Furthermore, in the example shown in FIG. 9, the principal axis X2 of the measuring tape is obtained by performing principal component analysis on the first to fifth reference positions L1 to L5. Based on the first to fifth reference positions L1 to L5 and their orientation, the image processing device 1 measures the size of the fish body.

### 10.1.5 Image Enhancement

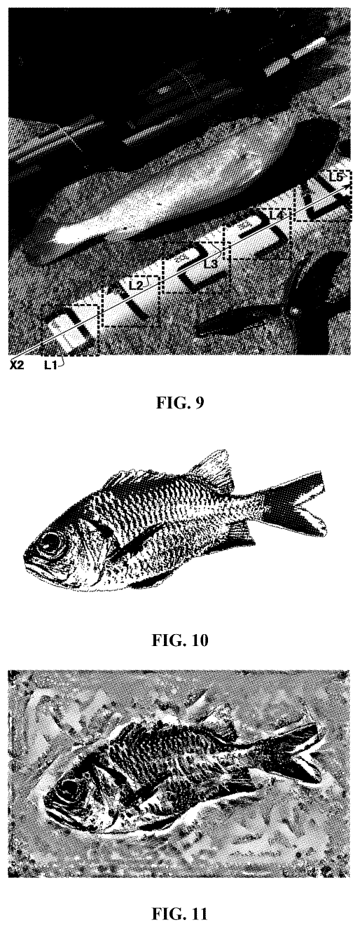

The image processing device 1 enhances the impact of the fish body image using Color Dodge, contrast normalization, and edge enhancement. FIG. 10 shows an example of an image obtained by enhancing the impact of the image in FIG. 8. By enhancing the impact, the resulting AI fish print image has a dynamic appearance, different from that of a simple monochrome image.

### 10.1.6 Neural Style Transfer

In response to a user's instruction, the image processing device 1 performs a neural style transfer. FIG. 11 shows an example of a fish print image in which the style of the fish body image in FIG. 10 has been transformed. In the example shown in FIG. 11, the AI fish print whose style has been transformed can give the impression of being an artistic work rather than merely a digital fish print.

### 10.2 Use in Fishing Tournaments and the Like Utilizing AI Fish Prints

The following describes an example in which AI fish prints are used in fishing tournaments and the like. As described above, the image processing system S according to the present embodiment enables rapid and accurate measurement using AI technology (machine learning and deep learning), as well as the drawing of AI fish prints based on such measurements.

In fishing tournaments that follow traditional procedures for measuring the size of fish and creating fish prints, the event venue is considered to be limited to locations where judges, fish print artisans, or the like can be arranged. Similarly, in fishing tournaments for creating digital fish prints using special photographic equipment, as in conventional methods, the event venue is considered to be limited to locations where such photographic equipment can be arranged.

In contrast, when using the image processing system S of the present embodiment, organizers of fishing tournaments and the like can hold such events regardless of whether a location allows the arrangement of facilities for measuring fish size or the arrangement of photographic equipment. This enables organizers to hold fishing tournaments over a broader range, exemplified by online fishing tournaments.

### 10.3 Commercialization of AI Fish Prints

The following describes an example of commercializing AI fish prints. As described above, the image processing system S according to the present embodiment enables rapid and accurate measurement using AI technology (machine learning and deep learning), as well as the creation of AI fish prints with an elegant style.

Accordingly, operators of the image processing system S and the like can provide services that sell various products designed with the generated AI fish prints. Examples of such products include, for instance, T-shirts, mugs, calendars, and New Year's greeting cards featuring AI fish prints.

### MODIFICATIONS

The above has described examples of preferred embodiments of the present invention. However, within the scope of the inventive concept of the present invention, those skilled in the art may conceive of various modifications and alterations. Therefore, such modifications and variations are understood to fall within the scope of the present invention in the same manner as the above examples.

For example, with respect to the embodiments described above, any addition, deletion, or design modification of components, or addition, omission, or condition change of steps, as appropriately carried out by those skilled in the art, shall be included within the scope of the present invention as long as the essential features of the invention are retained.

### EXPLANATION OF REFERENCE NUMERALS

| Reference | |
|---|---|
| Numeral | Description |
| S | Image Processing System |
| 1 | Image Processing Device |
| 11 | Controller |
| 111 | Image Acquisition Unit |
| 112 | Fish-Species Determination Unit |
| 113 | Fish-Body Segmentation Unit |
| 114 | Orientation Correction and Layout Optimization Unit |
| 115 | Reference-Positions Acquisition Unit |
| 116 | Measurement Unit |
| 117 | Image Enhancement Unit |
| 118 | Neural Style Transfer Unit |
| 119 | Output Unit |
| 12 | Storage Unit |
| 121 | Fish Print Table |
| 13 | Communication Unit |
| C | Caudal Fin |
| E | Eye |
| L1-L5 | First to Fifth Reference Positions |
| N | Network |
| P | Pectoral Fin |
| T | Terminal |
| X1 | First Principal Axis |
| Y1 | Second Principal Axis |
| X2 | Orientation of the Measuring Tape |

What is claimed is:

1. An image processing device for AI fish prints, comprising:
(A) a fish-species determination unit configured to determine a species of a fish from a fish image using a first machine learning model;
(B) a fish-body segmentation unit configured to segment a fish-body partial image corresponding to the fish body using a second machine learning model with weights trained in accordance with the fish species;
(C) an orientation correction and layout optimization unit configured to determine an orientation of the fish body in the fish-body partial image using a third machine learning model, correct the orientation, and perform layout optimization;
(D) a measurement unit configured to measure a size of the fish body based on the fish-body partial image and a plurality of reference positions serving as size references obtained from the image; and
(E) an output unit configured to output the layout-optimized fish-body partial image together with fish-species information.

2. The image processing device of claim 1, wherein the output unit is configured to output, to social media, the fish-body partial image whose orientation has been corrected and optimally positioned, together with fish-species information and size information.

3. The image processing device of claim 1, further comprising:
(F) an image enhancement unit configured to perform, based on an image enhancement algorithm, visual enhancement of the fish-body partial image by combining a Color Dodge technique, contrast normalization, and edge enhancement.

4. The image processing device of claim 1, further comprising:
(G) a neural style transfer unit configured to transform a style of the fish-body partial image using a fifth machine learning model.

5. The image processing device of claim 4, wherein the neural style transfer unit is configured, based on the fifth machine learning model, to create and/or modify a background and a font used in an AI fish print in accordance with a user's preference.
